(19) United States
(12) Patent Application Publication
(10) Pub. No.: US 2008/0279981 A1
(43) Pub. Date: Nov. 13, 2008

(54) RUMINANT FEEDS CONTAINING pH-ADJUSTED EDIBLE BYPRODUCTS AND HIGH DIGESTIVE EFFICIENCY GRAINS

(75) Inventors: Mark D. Miller, Elk City, OK (US); Timothy A. Murphy, Dodge City, KS (US)

Correspondence Address: HOVEY WILLIAMS LLP, 10801 Mastin Blvd., Suite 1000, Overland Park, KS, 66210, US

(73) Assignee: ByProduct Feed Technologies, LLC, Dodge City, KS (US)

(21) Appl. No.: 11/745,566

(22) Filed: May 8, 2007

(51) Int. Cl. A23K 1/06

(52) U.S. Cl. 426/31; 426/623; 426/624

(57) ABSTRACT

Improved ruminant feeds are provided which include a pH-adjusted first ingredient selected from the group consisting of ruminant-edible, initially low pH commercial byproducts and initially low pH grain or forage-derived products, combined with a second ingredient comprising a high digestive efficiency feed grain such as flaked corn. An improved process (10) for the production of a ruminant feed (50) as an adjunct to a fuel ethanol plant is also provided wherein starch-bearing grain (12) is processed to yield ethanol (30) and whole stillage (32). The whole stillage (32) is then treated to remove water and to yield a wet distiller's grain product (WDG) (38). The pH of the WDG (38) is then elevated (46) by the addition of base to a pH of from about 5-8, and the pH-adjusted WDG (46) is optionally dried (47) and combined with a high digestive efficiency feed grain (HDEG) such as flaked grain (48). The ruminant feeds (50) of the invention do not generate low rumen pH levels when consumed, and thus avoid rumen acidosis and related problems.

### BACKGROUND OF THE INVENTION

### Field of the Invention

The present invention is broadly concerned with the methods of producing ruminant feeds, and the resulting feeds themselves, wherein a first ingredient such as an edible commercial byproduct (e.g., wet distiller's grain (WDG)) or low pH grain or forage-derived products (e.g., initially low pH grain silage or haylage which has been treated to raise the pH thereof) is combined with high digestive efficiency feed grain (HDEG) such as flaked corn. More particularly, the invention pertains to such methods and feeds wherein relatively high quantities of the pH-adjusted first ingredient is employed in the feeds, so that when the feeds are consumed by ruminants low rumen pH levels are minimized. In this manner, substantial quantities of normally low pH ruminant-edible products can be used with HDEG products in the feeds, without creating low rumen pH problems such as clinical or subclinical acidosis, and while retaining the animal performance benefits of the high digestive efficiency feed grains.

### DESCRIPTION OF THE PRIOR ART

Ruminants are unique in that they do not directly digest the feedstuffs they consume, but instead a pre-gastric fermentation occurs whereby metabolic end products of digestion and much lower levels of consumed feedstocks reach the small intestine. Ruminal microbes act on carbohydrates to give volatile fatty acids (VFA), and also utilize non-protein nitrogen (e.g., urea, proteins, peptides, amino acids) to give microbial or bacterial crude protein of high value. The microbial protein then passes out of the rumen and is subjected to gastric digestion in the abomasum of the ruminant and is absorbed in the small intestine. The inherent characteristics or properties of feedstuffs consumed by the ruminants, such as moisture, pH, starch content and availability, crude protein level, and fat content, can have a pronounced affect on ruminal pH, VFA and microbial protein production, and ultimate growth potential of the animal.

It is known that processing of grains prior to consumption by ruminants can alter the efficiency with which the ruminants can convert the grain into weight gain or increased milk production. For example, the digestive efficiency of grain feedstuffs can be significantly increased (10-15%) by steam flaking grains (e.g., corn, sorghum, wheat or barley), wherein the grain is subjected to processing in a closed steam chest, followed by passing the steamed grain through pressure rollers to provide thin flakes. Digestive efficiencies achieved by steam flaking are based upon the fact that the moisturization, heating, and flaking steps gelatinizes some of the grain starch and increases the surface area of the grain, rendering the starch more susceptible to microbial processes within the rumen. See, U.S. Pat. No. 4,898,092 and Zinn et al., Flaking Corn: Processing Mechanics, Quality Standards, and Impacts on Energy Availability and Performance of Feedlot Cattle. J. Anim. Sci. 80:1145-56 (2002). Other grain processing techniques can also be used to increase the digestive efficiencies, e.g., dry grinding or rolling, treatments to increase the moisture content of the grain, and feeding certain types of whole high moisture early harvested ensiled grains. High digestive efficiency feed grain products are particularly attractive in regions where grain prices are relatively high, such as the U. S. Southern Plains, inasmuch as the higher digestive efficiencies give better performance in ruminant animals, especially cattle.

However, it has also been found that feeding high digestive efficiency feed grains can lower ruminal pH values owing to faster rates of VFA production. For example, while ruminal pH levels range from about 5.5-6.5 with normal ruminant diets, those containing significant flaked grain can depress rumen pH levels to around 4.5-5.5. While this problem represents a drawback, the extent of ruminal pH reduction observed with high digestive efficiency feed grain diets is not normally sufficient to overcome the feed efficiency advantages obtained with such diets. Nonetheless, care must be taken not to overfeed high digestive efficiency feed grains at levels which will adversely affect rumen pH and thus microbial processes in the rumen, including nitrogen utilization and starch and fiber digestion.

Ethanol plants utilize starch-bearing grains (typically corn sorghum, or wheat) so that the starch content thereof(about 67-72%) is converted to glucose using enzymes, and then fermented to ethanol (about 2.5-2.7 gal./bu) using yeast. Thereupon, the ethanol is distilled and recovered, leaving whole stillage as a commercial byproduct containing substantial protein, bran, and fat. The whole stillage is then centrifuged to yield WDG and thin stillage. The latter may be evaporated to give a condensate product and a concentrated solubles syrup. Typical corn WDG contains approximately 30% crude protein, 10% ether extract, and 9-10% crude fiber and ash (minerals) on a dry matter basis, and has a low pH on the order of 3.5-4.0 (Shirley, Energy and Nitrogen Utilization in Feedstuffs, XIV. Alcohol Production-Byproducts-Wet Distillers Grains (WDG). In Tony J. Cunha Ed., Nitrogen and Energy Nutrition of Ruminants-Animal Feeding and Nutrition, 201 (1986)). Generally, the WDG product from ethanol production is dried to give dried distiller's grains (DDG) which can be used as a feed supplement in ruminant feeds. However, the energy cost associated with drying WDG to DDG is considerable, and accounts for a high proportion of the ultimate cost of the dried product.

The ever-increasing cost of energy, particularly petroleum-based energy, has lead to a substantial increase in the number and size of fuel ethanol plants using cereal grains as feedstocks. Consequently, the present and anticipated volume of MG and WDG byproducts is very great, and finding economically advantageous uses for these potentially valuable byproducts has become a priority.

Normal WDG or DDG can be mixed with conventional feed ingredients such as whole and/or processed grain, roughage, and protein, mineral, and vitamin supplements to give complete ruminant feeds. When WDG is used with high digestive efficiency feed grains, the low pH of normal WDG significantly limits the amount of WDG which can be used. This is because, as noted previously, high digestive efficiency feed grains themselves tend to induce low pH values in the rumen, and thus the combination of high digestive efficiency feed grains with normal WDG can yield very low rumen pH levels. In fact, it has been determined that normal WDG can be used in flaked grain diets at levels of up to about 15% by weight maximum, dry basis, and in dry rolled and/or high moisture corn diets at levels of about 30-40% by weight maximum, on a dry basis. If greater amounts of normal WDG are used in such feeds, the low pHs thereof can lead to rumen acidosis and/or self-limiting of feed consumption by ruminant animals. Thus, while the volume of WDG as a byproduct of ethanol production is rapidly increasing, only a relatively small percentage thereof can be used in high digestive efficiency feed grain ruminant feeds.

Other types of edible commercial byproducts can also be used in ruminant feeds, but many of these byproducts present the same low-pH problem encountered with WDG. For example, processed high moisture corn contains in excess of 8% protein and over 86% total digestible nutrients, but has a low pH on the order of 3.7-4.2. Likewise, whey permeate contains significant digestible nutrients, but has a pH around 4.5. Corn gluten feed (wet or dry, for example the commercial product Sweet Bran), a byproduct of corn wet milling, is also a valuable feed product, but has a low pH. Accordingly, the use of any of these products with high digestible efficiency feed grains presents the same potential problem noted with WDG, namely excessively low ruminal pH values.

UA 66062 discloses a method wherein the distillery dregs from ethanol production are treated with calcium hydroxide in order to decrease the usage of fresh water in the ethanol process. Calcium hydroxide treatment of the distillery dregs yields a liquid fraction which can be used in lieu of fresh water in ethanol production, and the calcium ion present in the treated liquid fraction is asserted to assist in yeast fermentation. However, calcium hydroxide has very low water solubility, making it very difficult to carry out this process on a continuous, commercial scale.

Background patent references include: U.S. Pat. Nos. 4,624,805; 4,952,504; 5,023,091; 5,637,312; 5,908,634; 6,517,875; 6,726,941; and 6,838,099; U.S. Published Patent Applications Nos. 2003/0152689; 2005/0220951; 2005/0255220; 2007/0014905; and 2007/0036881.

There is accordingly a need in the art for improved processing techniques and resultant ruminant feeds, characterized by a greater than heretofore possible use of normally low-pH commercial byproducts and/or low pH grain-derived products in combination with high dietary efficiency feed grains.

### SUMMARY OF THE INVENTION

The present invention overcomes the problems outlined above, and provides improved ruminant feeds and methods for the production thereof. Broadly, the feeds of the invention include respective quantities of a first pH-adjusted ingredient selected from the group consisting of ruminant-edible commercial byproducts, low pH grain or forage-derived products, and mixtures thereof, and a second ingredient comprising high digestive efficiency feed grain. The edible byproducts are preferably selected from the group consisting of distiller's grain products (e.g., wet or dry distiller's grain products derived from ethanol production), wet or dry corn gluten feed, whey permeate, corn steep (condensed fermentive corn extractives derived from a wet corn milling plant where corn gluten feed is produced), and mixtures thereof, whereas the low pH grain or forage-derived products are preferably selected from the group consisting of initially low pH products such as grain silages (e.g., corn, wheat, sorghum), and haylages which have been treated to elevate the pH thereof, and mixtures of the foregoing. The first ingredient is used at levels greater than about 15% by weight (more preferably from about 16-80% by weight, most preferably about 30-80% by weight), dry basis. The first ingredient is pH-adjusted to a level from about 5-8, more preferably about 5.5-6.5, using a base having a solubility in water of at least about 60 g/100 ml at 25° C., such as the readily available alkali metal hydroxides. It is preferred that such pH adjustments be carried out as a part of the manufacturing or processing procedures leading to the first ingredients, but in any case preferably prior to mixing of the first and second ingredients.

The preferred second ingredient HDEG products are selected from the group consisting of flaked grain, hard rolled grain, high moisture, early harvested (i.e., before full maturity thereof), ensiled grain and mixtures thereof. The single most preferred HDEG product is flaked corn. In normal practice, the pH-adjusted first ingredient is mixed with the second ingredient HDEG products along with other normal ruminant feed ingredients such as vitamin and mineral supplements and roughages, to give a complete ruminant diet.

In another aspect of the invention, methods of producing a ruminant feed are provided as an adjunct to grain feedstock fuel ethanol production. Such methods comprise the steps of providing a source of starch-bearing grain, and processing the grain to yield ethanol and aqueous whole stillage. The whole stillage is then treated to remove at least some of the water therefrom, and to yield a distiller's grain product. The pH of the distiller's grain product is adjusted to a level of from about 5-8 (more preferably from about 5.5-6.5) using an appropriate high water solubility base such as sodium hydroxide, and this pH-adjusted product is combined with a high digestive efficiency feed grain (and typically vitamin and mineral supplements and forages) to give a ruminant feed.

As indicated, this aspect of the invention is carried out as a part of ethanol production in a standard fuel ethanol production facility. In such a context, the ethanol production process is modified by pH adjustment of the distiller's grain byproduct. Thereafter, the distiller's grain product may be used directly as a wet distiller's grain product (WDG) or it may be dried to give a dried distiller's grain product (DDG). Advantageously, the wet distiller's grain product is used, thereby avoiding the need to dry the product with attendant energy costs. In any case, the pH-adjusted distiller's grain product is combined with high digestive efficiency feed grains to yield a ruminant feed. This can be carried out at the ethanol plant site, or can be done at a different location such as a feedlot. In preferred forms, the pH-adjusted distiller's grain byproduct is made up of WDG plus solubles syrup derived from the thin stillage of the ethanol process.

An important feature of this aspect of the invention is the discovery that relatively high quantities of low cost pH-adjusted edible commercial byproduct can be used with high digestive efficiency feed grains to give higher quality rumen feeds, while at the same time avoiding the problem of low rumen pH levels when the feeds are consumed by ruminants, especially cattle.

### BRIEF DESCRIPTION OF THE DRAWING

The single Figure is a schematic flow diagram illustrating the production of an illustrative ruminant feed product in accordance with the invention.

### DETAILED DESCRIPTION OF THE PREFERRED EMBODIMENTS

The present invention is directed to improved ruminant feeds comprising a first pH-adjusted ingredient in the form of initially low pH ruminant-edible commercial byproducts, initially low pH grain or forage-derived products, and mixtures thereof, together with a second ingredient comprising high digestive efficiency feed grains. As used herein, “edible commercial byproducts” refers to low pH (generally below about pH 5) edible grain or dairy product-derived materials which are produced on a commercial basis as a byproduct adjunct or coproduct during the production of primary saleable products. For example, grain feedstock fuel ethanol plants are primarily directed to the production of fuel ethanol, but as a byproduct substantial quantities of distiller's grain products are produced. Other examples include whey permeate derived from cheese production, wet or dry corn gluten feed resulting from the wet milling of corn, and corn steep derived from wet corn milling. “Low pH grain or forage-derived products” refers to grain products which are processed and have a low initial pH, normally below about 5, typically corn, wheat, and sorghum silages or haylages which are pH adjusted in accordance with the invention. “High digestive efficiency feed grains” means grains which have been processed so that the digestive efficiency thereof is at least about 5% greater than the digestive efficiency of their unprocessed or normally mature harvested grain counterparts. More preferably, the increased digestive efficiency should be at least about 10%. Digestive efficiencies can be determined by known in vitro methods or most preferably by side-by-side in vivo feeding studies using the processed grains versus the comparative unprocessed native grains, to determine differences in selected animal performance parameter(s), such as weight gain or milk production. For example, flaked corn exhibits an increased digestive efficiency on the order of 10-15% in terms of animal weight gain, as compared with unprocessed corn.

The second ingredient of the feeds is variable, depending upon the type of high digestive efficiency feed grain employed, as well as the presence of other ingredients. Generally speaking, the feeds of the invention should contain from about 10-60% by weight, more preferably about 20-50% by weight, of selected high digestive efficiency feed grain products.

In particularly preferred forms, the invention provides methods for producing ruminant feeds using distiller's grain products as the first pH-adjusted ingredient. The single Figure depicts an exemplary process in accordance with this aspect of the invention. Broadly speaking, in this method starch-bearing grain is processed to yield ethanol and aqueous whole stillage, and the latter is treated to remove some liquid and yield WDG. The pH of the WDG is then adjusted using a strong base, and this WDG, in wet and/or dried form, is thereupon combined with a representative high digestive efficiency feed grain, such as flaked grain, to give a ruminant feed.

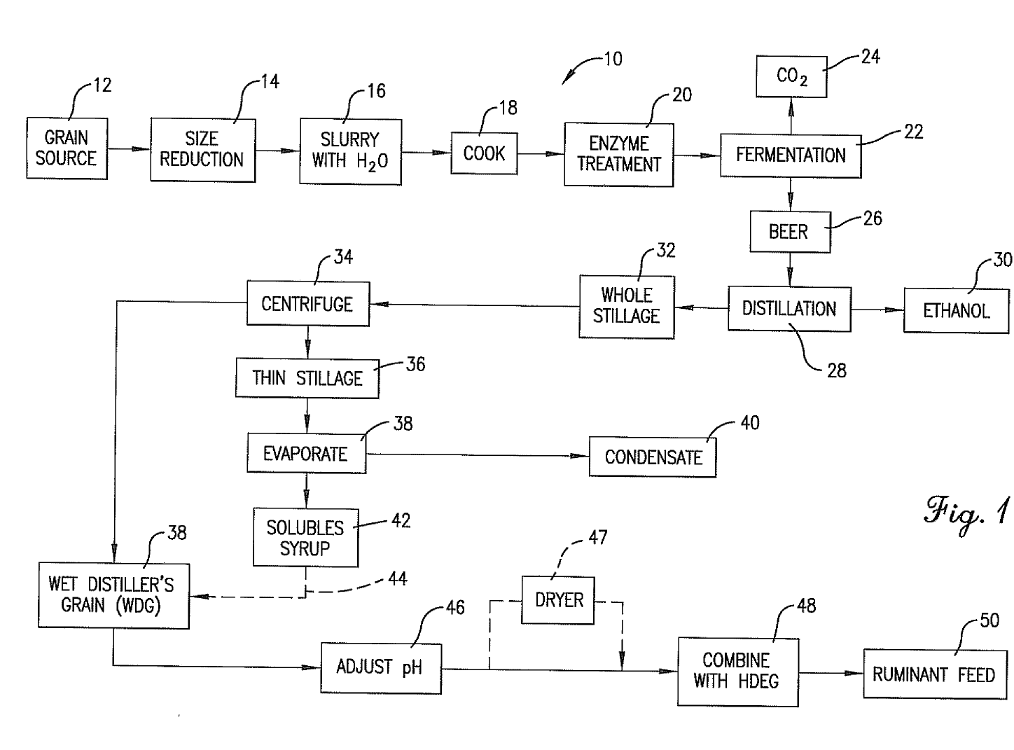

In more detail, the FIG. 1 process 10 begins with a source of starch-bearing grain 12 such as corn, sorghum, wheat and/or barley, typically having from about 67-72% starch content. This grain is initially processed to obtain size reduction as shown in step 14, usually by use of a hammer mill or other type of grinder. Next, the grain is slurried with water (step 16), followed by conventional cooking and enzyme treatment (steps 18 and 20) to convert the starch to glucose. Next, the cooked and enzyme treated product is fermented with yeast in step 22, giving carbon dioxide as an off gas (step 24), and a fermentation beer, step 26. The beer is then distilled in step 28, giving recoverable ethanol, step 30, and whole stillage, step 32. The ethanol is then further treated to remove residual water by conventional techniques such as use of molecular sieves, giving pure 200 proof ethanol.

The whole stillage from step 32 is an aqueous product containing some solids and substantial liquid content. In the next step 34, the whole stillage is centrifuged to give thin stillage, step 36, and WDG, step 38. The thin stillage from step 36 is then typically evaporated in step 38 to give a condensate, step 40, and a solubles syrup, step 42. Optionally, the solubles syrup may be added to the WDG, as indicated by dotted arrow 44.

The wet distiller's grain product, with or without inclusion of the solubles syrup, is next pH-adjusted in step 46, to a pH of from about 5-8, more preferably from about 5.5-6.5. This involves addition of strong, water soluble base preferably having a solubility in water of at least about 60 g/100 ml at 25° C. (e.g., an alkali metal base such as concentrated sodium hydroxide), to the WDG product with appropriate mixing to assure substantial pH homogeneity. Other bases could also be used, such as potassium hydroxide or ammonium hydroxide, all of these bases being generally recognized as safe (GRAS). However, NaOH is preferred because it is readily available and relatively inexpensive. Moreover, it is preferred that the pH adjustment be a part of the otherwise normal ethanol plant production, as opposed to off-site pH treatment. The latter would be very difficult, particularly at feedlot sites, and could be dangerous owing to the characteristics of concentrated NaOH.

Optionally, the wet distiller's grain can be partially or wholly dried (step 47) to give a dried distiller's grain product (DDG). If desired, a portion of the pH-adjusted WDG can be dried to a DDG product. However, for reasons of economy, it is preferred to use the pH-adjusted WDG without the optional drying step.

The pH-adjusted distiller's grain product, in the form of WDG, DDG or mixtures thereof, is next combined with HDEG feed ingredients such as flaked grain, step 48, to yield a final ruminant feed, step 50. A prime goal of such feed production is to maximize use of the pH-adjusted distiller's grain product, because of its relatively low cost. Accordingly, the pH-adjusted distiller's grain product is used at levels of greater than 15% by weight in the feed 50, dry basis. It will of course be understood that other conventional feed ingredients may be used with the pH-adjusted distiller's grain products and the HDEG products. Such may include whole or otherwise processed grains, forages (roughages), as well as protein, mineral, and/or vitamin supplements, as well as other known feed additives.

Three samples of WDG derived from an ethanol plant using corn and milo as feedstocks were analyzed, along with a sample of ground high moisture corn and a sample of dry rolled high moisture corn. These samples were then adjusted to a pH of 6.0 using concentrated sodium hydroxide. The two corn-derived WDG samples had initial pHs of 4.51 and 4.03, respectively, and 0.00237 and 0.00426 gm concentrated NaOH per gram were required to raise these pH levels to 6.0. The milo-derived WDG sample had an initial pH of 3.80, and 0.00860 gm concentrate NaOH per gram were required to elevate the pH to 6.0. The ground high moisture corn had an initial pH of 4.32, and 0.00475 gm of concentrated NaOH per grain were needed to achieve a 6.0 pH. Finally, the dry rolled high moisture corn had an initial pH of 4.26, and required 0.00242 gm of concentrated NaOH per gram to reach a pH of 6.0. This study demonstrated that the amount of base required to elevate the pH was greater for the WDG samples than for the high moisture corn samples. These increased buffering capacities suggest that WDG has a more severe lowering effect on ruminal pH as compared with the high moisture corn samples, and that pH adjustment of WDG to a level close to neutral should prevent very low ruminal pH levels, to thus improve ruminal ammonia balance, starch digestion, and microbial protein synthesis, all leading to improved animal performance.

Representative ruminant feeds which maybe formulated in accordance with the invention and containing substantial amounts of pH-adjusted WDG are set forth in the Table 2, which gives growing, daily and finishing diets for cattle. Table 1 illustrates diets containing non-pH adjusted WDG in smaller quantities, as compared with the Table 2 diets.

TABLE 1

| | | Finishing | | | Dairy | | | Growing | | |
|---|---|---|---|---|---|---|---|---|---|---|
| | | Diet | As Fed | As Fed | Diet | As Fed | As Fed | Diet | As Fed | As Fed |
| Ingredients | % DM | % DMB | Parts | % | % DMB | Parts | % | % DMB | Parts | % |
| Flaked Corn | 78.00% | 68.50 | 87.82 | 54.97% | 8.50 | 10.90 | 5.57% | 13.00 | 16.67 | 6.28% |
| Ground Alfalfa Hay | 85.00% | 3.50 | 4.12 | 2.58% | 25.00 | 29.41 | 15.05% | | 0.00 | 0.00% |
| Corn Silage | 32.00% | 5.50 | 17.19 | 10.76% | 25.00 | 78.13 | 39.97% | 40.00 | 125.00 | 47.13% |
| WDG | 35.00% | 15.00 | 42.86 | 26.83% | 10.00 | 28.57 | 14.62% | 25.00 | 71.43 | 26.93% |
| WCGF | 40.00% | | 0.00 | 0.00% | 10.00 | 25.00 | 12.79% | 20.00 | 50.00 | 18.85% |
| DDG | 90.00% | | 0.00 | 0.00% | 5.00 | 5.56 | 2.84% | | 0.00 | 0.00% |
| Whole Cottonseed | 91.00% | | 0.00 | 0.00% | 10.50 | 11.54 | 5.90% | | 0.00 | 0.00% |
| Soybean Meal | 89.50% | | 0.00 | 0.00% | 3.00 | 3.35 | 1.71% | | 0.00 | 0.00% |
| Finisher Supplement | 95.00% | 5.00 | 5.26 | 3.29% | | 0.00 | 0.00% | | 0.00 | 0.00% |
| Dairy Mineral | 99.00% | | 0.00 | 0.00% | 1.00 | 1.01 | 0.52% | | 0.00 | 0.00% |
| Grow Supplement | 95.00% | | 0.00 | 0.00% | | 0.00 | 0.00% | 2.00 | 2.11 | 0.79% |
| Tallow | 99.50% | 2.50 | 2.51 | 1.57% | 2.00 | 2.01 | 1.03% | | 0.00 | 0.00% |
| Total | | 100.0 | 159.76 | 100.00% | 100.00 | 195.47 | 100.00% | 100.00 | 265.20 | 100.00% |
| Ration DM % | | | | 62.59% | | | 51.16% | | | 37.71% |

WCGF = Wet Corn Gluten Feed

TABLE 2

| | | Finishing | | | Dairy | | | Growing | | |
|---|---|---|---|---|---|---|---|---|---|---|
| | | Diet | As Fed | As Fed | Diet | As Fed | As Fed | Diet | As Fed | As Fed |
| Ingredients | % DM | % DMB | Parts | % | % DMB | Parts | % | % DMB | Parts | % |
| Flaked Corn | 78.00% | 53.50 | 68.59 | 37.40% | 0.00 | 0.00 | 0.00% | 0.00 | 0.00 | 0.00% |
| Ground Alfalfa Hay | 85.00% | 3.50 | 4.12 | 2.25% | 22.50 | 26.47 | 11.93% | | 0.00 | 0.00% |
| Corn Silage | 32.00% | 5.50 | 17.19 | 9.37% | 22.50 | 70.31 | 31.68% | 40.00 | 125.00 | 43.92% |
| WDG (pH Adjusted) | 35.00% | 30.00 | 85.71 | 46.74% | 25.00 | 71.43 | 32.18% | 35.00 | 100.00 | 35.14% |
| WCGF(pH Adjusted) | 40.00% | | 0.00 | 0.00% | 15.00 | 37.50 | 16.90% | 23.00 | 57.50 | 20.20% |
| DDG | 90.00% | | 0.00 | 0.00% | 1.50 | 1.67 | 0.75% | | 0.00 | 0.00% |
| Whole Cottonseed | 91.00% | | 0.00 | 0.00% | 10.50 | 11.54 | 5.20% | | 0.00 | 0.00% |
| Soybean Meal | 89.50% | | 0.00 | 0.00% | 0.00 | 0.00 | 0.00% | | 0.00 | 0.00% |
| Finisher Supplement | 95.00% | 5.00 | 5.26 | 2.87% | | 0.00 | 0.00% | | 0.00 | 0.00% |
| Dairy Mineral | 99.00% | | 0.00 | 0.00% | 1.00 | 1.01 | 0.46% | | 0.00 | 0.00% |
| Grow Supplement | 95.00% | | 0.00 | 0.00% | | 0.00 | 0.00% | 2.00 | 2.11 | 0.74% |
| Tallow | 99.50% | 2.50 | 2.51 | 1.37% | 2.00 | 2.01 | 0.91% | | 0.00 | 0.00% |
| Total | | 100.00 | 183.38 | 100.00% | 100.00 | 221.94 | 100.00% | 100.00 | 284.61 | 100.00% |
| Ration DM % | | | | 54.53% | | | 45.06% | | | 35.14% |

WCGF = Wet Corn Gluten Feed

It will thus be seen that the present invention provides improved ruminant feeds and production methods permitting use of substantial quantities of high digestive efficiency feed grains and low cost, pH-adjusted commercial byproducts and/or low-pH grain-derived products. Such feeds largely avoid the problem of low rumen pH levels when consumed by ruminant animals.

We claim:

1. A ruminant feed comprising respective quantities of a first pH-adjusted ingredient selected from the group consisting of edible commercial byproducts, low pH grain or forage-derived products, and mixtures thereof, and a second ingredient comprising high digestive efficiency feed grain.

2. The feed of claim 1, said byproduct selected from the group consisting of distiller's grain products, corn gluten feed, whey permeate, corn steep, and mixtures thereof, and said low pH grain or forage-derived products selected from the group consisting of grain silages, haylages, and mixtures thereof.

3. The feed of claim 2, said distiller's grain products selected from the group consisting of wet distiller's grain products and dry distiller's grain products.

4. The feed of claim 1, said pH-adjusted first ingredient being present at a level of greater than about 15% by weight, dry basis.

5. The feed of claim 4, said level being from about 16-80% by weight, dry basis.

6. The feed of claim 1, said high digestive efficiency feed grain selected from the group consisting of flaked grain, dry rolled grain, ground grain, high moisture, early harvested, ensiled grains, and mixtures thereof.

7. The feed of claim 6, said high digestive efficiency feed grain comprising flaked corn.

8. The feed of claim 1, said first ingredient being adjusted to a pH of from about 5-8.

9. The feed of claim 8, said pH being from about 5.5-6.5.

10. The feed of claim 1, said first ingredient being treated with a base to adjust the pH thereof.

11. The feed of claim 10, said base having a solubility in water of at least about 60 g/100 ml at 25° C.

12. The feed of claim 1, said first ingredient selected from the group consisting of wet distiller's grain products and dried distiller's grain products.

13. The feed of claim 12, said first ingredient derived from ethanol production.

14. A method of producing a ruminant feed comprising the steps of mixing together respective quantities of a first pH-adjusted ingredient selected from the group consisting of edible commercial byproducts, low pH grain or forage-derived products, and mixtures thereof, and a second ingredient comprising high digestive efficiency feed grain.

15. The method of claim 14, said byproduct selected from the group consisting of distiller's grain products, corn gluten feed, whey permeate, corn steep, and mixtures thereof, and said low pH grain or forage-derived products selected from the group consisting of grain silages, haylages, and mixtures thereof.

16. The method of claim 15, said distiller's grain products selected from the group consisting of wet distiller's grain products and dry distiller's grain products.

17. The method of claim 14, said pH-adjusted first ingredient being present at a level of greater than about 15% by weight, dry basis.

18. The method of claim 17, said level being from about 16-80% by weight, dry basis.

19. The method of claim 14, said high digestive efficiency feed grain selected from the group consisting of flaked grain, dry rolled grain, ground grain, high moisture, early harvested, ensiled grains, and mixtures thereof.

20. The method of claim 19, said high digestive efficiency feed grain comprising flaked corn.

21. The method of claim 14, said first ingredient being adjusted to a pH of from about 5-8.

22. The method of claim 21, said pH being from about 5.5-6.5.

23. The method of claim 14, said first ingredient being treated with a base to adjust the pH thereof.

24. The method of claim 23, said base having a solubility in water of at least about 60 g/100 ml at 25° C.

25. The method of claim 14, said first ingredient selected from the group consisting of wet distiller's grain products and dried distiller's grain products.

26. The method of claim 25, said first ingredient derived from ethanol production.

27. A method of producing a ruminant feed comprising the steps of:
providing a source of starch-bearing grain;
processing said grain to yield ethanol and aqueous whole stillage;
treating said whole stillage to remove at least some of the water therefrom, and to yield a distiller's grain product;
adjusting the pH of said distiller's grain product to a level of from about 5-8 to give a pH-adjusted distiller's grain product; and
combining said pH-adjusted distiller's grain product mad high digestive efficiency feed grain to give a ruminant feed.

28. The method of claim 27, said ruminant feed including greater than 15% by weight of said distiller's grain product, dry basis.

29. The method of claim 28, said feed including from about 16-80% by weight of said distiller's grain product, dry basis.

30. The method of claim 27, including the step of treating said whole stillage to yield thin stillage, evaporating the thin stillage to give a solubles syrup, and adding said solubles syrup to said distiller's grain product.

31. The method of claim 27, said pH level being from about 5.5-6.5.

32. The method of claim 27, said pH adjustment step comprising the step of adding a base to said distiller's grain product.

33. The method of claim 32, said base having a solubility in water of at least about 60 g/100 ml at 25° C.

34. The method of claim 27, said grain processing step comprising the steps of forming an aqueous slurry of said grain, cooking the aqueous slurry, fermenting the cooked slurry to yield a process beer, and distilling said beer to yield said ethanol and said whole stillage.

35. The method of claim 27, said high digestive efficiency feed grain selected from the group consisting of flaked grain, dry rolled grain, ground grain, high moisture, early harvested, ensiled grains, and mixtures thereof.

36. The method of claim 35, said high digestive efficiency feed grain comprising flaked grain.

37. The method of claim 36, said flaked grain comprising flaked corn.

38. The method of claim 27 including the step of at least partially drying said pH-adjusted distiller's grain product, prior to said combining step.

39. The method of claim 38, including the step of substantially completely drying said pH-adjusted distiller's grain product to give a pH-adjusted dried distiller's grain product, and combining said pH-adjusted dried distiller's grain product with said high digestive efficiency feed grain.

40. A ruminant feed product comprising a distiller's grain product having an adjusted pH of from about 5-8, and combined with high digestive efficiency feed grain.

41. The feed product of claim 40, said distiller's grain product being a wet distiller's grain product and having an adjusted pH of from about 5.5-6.5.

42. The feed product of claim 40, said distiller's grain product being a dried distiller's grain product and having said adjusted pH prior to drying thereof.

43. The feed product of claim 40, said distiller's grain product being pH-adjusted with sodium hydroxide.

44. The feed product of claim 40, said distiller's grain product being derived from the production of ethanol.

45. The feed product of claim 44, said distiller's grain product also including a quantity of solubles syrup derived from said production of ethanol.

46. The feed product of claim 40, said distillers grain product being present in said feed at a level of greater than 15% by weight, dry basis.

47. The feed product of claim 46, said level being from about 16-80% by weight of said distiller's grain product, dry basis.

48. The feed product of claim 40, said high digestive efficiency feed grain selected from the group consisting of flaked grain, hard rolled grain, high moisture early harvested, ensiled grains, and mixtures thereof.

49. The feed product of claim 48, said high digestive efficiency feed grain comprising flaked grain.

50. The feed product of claim 49, said flaked grain comprising flaked corn.
